(19) United States
(12) Patent Application Publication
(10) Pub. No.: US 2015/0266194 A1
(43) Pub. Date: Sep. 24, 2015

(54) BLADE, IN PARTICULAR OSCILLATING BLADE, TO BE USED IN A MACHINE CUTTING METHOD FOR CUTTING SANDWICH PLATES

(71) Applicant: Zund Systemtechnik AG, Altstatten (CH)

(72) Inventors: Daniel LEDERGERBER, Rebstein (CH); Claude ZIMMERMANN, Arbon (CH); Simon JANN, Altstatten (CH)

(21) Appl. No.: 14/593,852

(22) Filed: Jan. 9, 2015

(30) Foreign Application Priority Data
Jan. 10, 2014 (EP) 14150776.4

(51) Int. Cl. B26D 1/00; B26D 1/58

(52) U.S. Cl. CPC B26D 1/0006; B26D 1/585; B26D 2001/0053

(57) ABSTRACT

A cutting machine blade to cut a multiwalled composite plate is disclosed. The cutting machine blade machine blade is guided by the cutting machine in a feed direction along the composite plate and has a holding section for fitting the cutting machine blade into a blade holder of the cutting tool, and a cutter with an edge, a first zone of the edge being provided for cutting a lower wall of the composite plate, and a second zone of the edge being provided for cutting an upper wall of the composite plate, and respective profiles of the edge in the region of the first and second zones respectively making a first angle of between about 30° and about 70° with the feed direction.

### CROSS-REFERENCE TO RELATED APPLICATIONS

This application claims priority to European Patent Application No.: 14150776.4, which was filed in Europe on Jan. 10, 2014, and which is herein incorporated by reference in its entirety

### BACKGROUND

The invention relates to a blade, in particular an oscillating blade, to be fitted in a cutting tool, particularly an oscillating cutting tool of a cutting machine, according to the precharacterizing clause of independent claim 1.

Machine oscillating cutting methods and cutting machines with an e.g. oscillating—i.e. driven—cutting tool, as well as oscillating blades suitable therefor, so that provision is made in particular for the cutting of a multiwalled composite plate—particularly a sandwich plate—are known in the prior art.

In this context, a multiwalled composite plate is intended to mean a sandwich plate made particularly of cardboard or paperboard material or plastic, which is made of at least an upper wall and separated therefrom a lower wall, which are respectively relatively thick and difficult to cut, and has an intermediate layer lying between them, which is relatively easy to cut, particularly in the form of an intermediate structure between five and 60 millimeters high, which consists for example of a thin-walled cardboard or paperboard material—for instance formed as a honeycomb structure—or lightweight plastic—for instance foam.

In order to cut such plates, it is known that the cutting machine and a correspondingly formed cutting tool therefor may provide a stroke cutting mode in which the plates can be cut, or trimmed as desired. In such a stroke cutting mode, for example, a blade fitted into a blade holder of the cutting tool can be moved by means of the cutting tool and the cutting machine in an oscillating fashion in a stroke direction down and up essentially perpendicularly to the composite plate to be cut, and can be guided along the composite plate in a feed direction. In particular, the stroke cutting mode may in this case have for example a stroke of between about 0.2 and about 12 millimeters, a stroke frequency of between about 50 and about 800 Hz (with a sinusoidal linear stroke movement), and a cutting speed in the feed direction of between about 0.1 and about 4 meters per second.

Oscillating cutting offers—compared for example with draw cutting, which is carried out by using a non-self-driven cutting tool with a fitted draw blade—for example the following advantages:

The main cutting direction is essentially vertical instead of horizontal. The horizontal cutting forces are reduced.

As the person skilled in the art knows, oscillating processing is suitable in this case particularly for cutting thick and tough materials. The displacement force in the running direction (also referred to as the feed direction) is reduced by the oscillating movement of the blade.

However, the feed speed must be adapted to the blade geometry and the oscillating frequency of the tool used. The choice of the correct oscillating blade depends above all on the processing contour:

For large radii, straight lines and large parts, it tends to be recommendable to use rather flattened blades.

The field of use for sharp blades relates in particular to the processing of fine radii and small parts. The feed speed should in this case generally be reduced in comparison with the use of flat blades, in order to achieve a sufficient cutting result.

Relatively flat blades (see FIGS. 2e-2h) are in this case in particular for:
high processing speed
large radii, straight lines or large parts

Relatively sharp blades (see FIGS. 1, 2a-2d) are in this case in particular for:
low processing speed
fine radii, or small parts

A disadvantage which has been found with the use of relatively flat blades—i.e. blades which are intended for the field of use with high processing speeds and large radii, straight lines, or large parts—is that—depending on the angle of the edge (i.e. “steepness” of the shape of the edge) either the cutting angle must be selected to be suboptimal (since it is too steep) or—in the case of a flat edge shape—when cutting shaped parts made of thick composite plates (such as sandwich plates having at least two thick walls and a structure lying between them), which may then overall be for example 10, 16 or 20 mm thick, undesired overcuts in the material are respectively necessary, which inter alia also complicates the calculation of the cutting paths.

### SUMMARY

The object is therefore to provide an improved blade to be fitted into a cutting tool of a cutting machine, which is intended and provided in order to cut composite plates such as sandwich plates, particularly with the blade being intended for high processing speeds and large radii, straight lines, or large parts.

In particular, the intention here is to reduce or eliminate the aforementioned disadvantages of the flat oscillating blades hitherto used for this special application area. In particular, a better compromise is intended to be provided here between a steep shape of the edge with a consequently suboptimal edge angle (although little overcut) and a flat shape (inclined less relative to the feed direction) of the edge with an optimized cutting angle (although with significant undesired overcut).

These objects are achieved by implementing the characterizing features of the independent claims. Features which refine the invention in an advantageous or alternative way may be found in the dependent patent claims.

The subject matter according to the invention relates to a cutting machine blade to be fitted into a cutting tool of a cutting machine, formed and accurately provided in order to cut a multiwalled composite plate—particularly a sandwich plate—made of cardboard or paperboard material or plastic, which has at least an upper wall and separated therefrom a lower wall, which are respectively relatively thick and difficult to cut, and an intermediate layer lying between them, which is relatively easy to cut, particularly in the form of a structure between five and 60 millimeters high made of material with cavities, in particular formed as a repeating cell pattern structure or from foam.

The cutting machine blade is in this case intended for use in the scope of an automatic cutting mode, in which the cutting machine blade is guided by the cutting machine in a feed direction along the composite plate. In particular, the cutting blade is configured as a flat blade and is intended for use in a cutting mode in which large radii or straight lines or large parts of composite plates are are cut at relatively high processing speeds (feed speeds).

The cutting machine blade has a holding section for fitting the cutting machine blade into a blade holder of the cutting tool, and a cutter with an edge.

According to the invention, the cutter is now divided, or the geometry of the edge is selected, in such a way that
a first zone of the edge extending obliquely relative to the feed direction is provided for cutting the lower wall,
a second zone of the edge extending obliquely relative to the feed direction is provided for cutting the upper wall, respective profiles of the edge in the region of the first and second zones respectively making a first angle of between about 30° and about 70° with the feed direction, and that
there is an intermediate zone of the edge between the first and second zones, with a profile that makes a second angle with the feed direction which is greater than the first angle, in particular greater than 90°.

The effect thereby achievable according to the invention is that, when cutting shaped parts made of relevant composite plates (such as sandwich plates with at least two thick walls and a structure lying between them, which may for example overall be for example 10, 16 or 20 mm thick), undesired overcuts in the material can respectively be reduced or even entirely avoided, which can inter alia also simplify the calculation of the cutting paths significantly. By the invention, the upper and lower walls of the composite plate can now be cut in the feed direction with essentially the same cutting advance, without the upper plate always already being significantly cut further than the lower plate at the same times in each case (or the cut in the lower wall respectively lagging significantly behind the cut in the upper wall).

The edge may advantageously extend obliquely backward here—relative to the feed direction—in the region of the intermediate zone, in particular in such a way that the shapes of the edge within the first and second zones—respectively projected orthogonally on to the feed direction—at least partially overlap, and in particular overlap essentially fully, in particular so that the shapes of the edge within the first and second zones are essentially parallel, and are only offset in a direction orthogonal to the feed direction.

In the context of this invention, the first zone of the edge is formed here by that section of the edge which is accurately intended and made in order to cut the lower wall of the composite plate in a defined cutting mode, which is then accurately intended for this blade. The second zone of the edge in the context of this invention is formed here by that section of the edge which is accurately intended and made in order to cut the upper wall of the composite plate in a defined cutting mode, which is then accurately intended for this blade.

The angles mentioned above and also indicated below, which the respective profiles of the edge in the respective zones make with the feed direction, are to be understood as angles which form a respective main extent direction of the respective profiles in the respective zones with the feed direction (respectively the smaller of the two angles formed between the vectors, considered when the respective vector start points of the two vectors are placed on one another). If a profile in a zone does not extend in a straight line here, then a main extent of the profile should be considered, or a direction in which the profile in the corresponding zone essentially extends on average (away from the cutter tip vertex in the direction of the blade neck). To this end, the extent direction of a profile within a respective zone is therefore considered in the basic direction in which the edge extends away from its origin in the cutter tip (i.e. away from the cutter tip in the direction of the blade neck, or the holding region of the blade [and—in embodiments in which the cutter tip vertex (lowermost point) does not lie on the cutter back and a “back-cutting” tip section is formed between the cutter tip and the cutter back—optionally also away from the cutter tip vertex in the direction of the back]).

As a consequence of the rearward offset according to the invention of the second zone of the blade, although the intermediate region is now aligned suboptimally in respect of its cutting angle with respect to the composite plate intermediate structure likewise to be cut through, this drawback (compromise) overall has an insubstantial effect on the cutting results, since the intermediate structure precisely consists of easily cuttable material (in particular with cavities) and can therefore be cut sufficiently well even with a suboptimal cutting angle.

The invention may, in particular, involve an oscillating blade to be fitted in an oscillating cutting tool. The oscillating blade should then be formed in such a way that it is specially provided and intended for use within the scope of a defined stroke cutting mode, in which the blade—in addition to the guiding along the feed direction—is moved in an oscillating fashion by the cutting tool in a stroke direction up and down essentially perpendicularly to the composite plate to be cut. The stroke movement itself may in particular be configured linearly sinusoidally, so that a sinusoidal curve as a combined movement path is obtained in combination from the two movements. An alternative, however, is also a stroke movement with uniform movement for the lowering as well as uniform movement for the raising (so that a sawtooth-like curve is obtained as a path in combination with the forward movement).

In particular, the stroke cutting mode, for which the blade is made, may have a stroke of between about 0.2 and about 12 millimeters, a stroke frequency of between about 50 and about 800 Hz and a cutting speed in the feed direction of between about 0.1 and about 4 meters per second.

In more particular embodiments, the stroke cutting mode for which the blade is made may have
a stroke of between about one and about five millimeters, particularly between about two and about three millimeters, in particular about 2.5 millimeters,
a stroke frequency of between about 100 and about 500 Hz, particularly between about 200 and about 300 Hz, in particular about 250 Hz, and
a cutting speed in the feed direction of between about 0.5 and about 2 meters per second, particularly between about 0.75 and about 1.5 meters per second, in particular about one meter per second.

As already mentioned above, oscillating cutting offers—compared for example with draw cutting, which is carried out by using a non-self-driven cutting tool with a fitted draw blade—for example the advantages that the main cutting direction is essentially vertical instead of horizontal, and the horizontal cutting forces are therefore reduced (so that this technique has to date typically been used for composite plates with relatively thick and solid upper and lower walls).

However, it is also readily possible to produce, according to the invention, a draw blade intended for composite plates, which has an intermediate zone that sets back the second zone of the edge.

Furthermore, a blade which is especially formed and provided in order to cut a multi-sandwich plate, the concept of the teaching according to the invention respectively with a plurality of wall cutting zones and respectively a plurality of “setting back” intermediate zones, may also be formed in such a way that a wall cutting zone adjacent above an intermediate zone (in comparison with the wall cutting zone adjacent underneath) is offset backward (considered in the feed direction) by the shape of the edge within the intermediate zone, in the context of the teaching according to the invention described above.

Furthermore, the invention also relates to a cutting machine having a cutting tool, which has a blade holder in which a cutting machine blade according to the invention—as described above—is fitted. The cutting machine provides a cutting mode in which the cutting machine blade is guided by the cutting machine in a feed direction along the composite plate. In the cutting mode, the cutting machine with the fitted cutting machine blade is then accurately formed and provided in order to cut a multiwalled composite plate—particularly a sandwich plate—made of cardboard or paperboard material or plastic, which has at least an upper wall and separated therefrom a lower wall, which are respectively relatively thick and difficult to cut, and an intermediate layer lying between them, which is relatively easy to cut, particularly in the form of a structure between five and 60 millimeters high made of material with cavities, in particular formed as a repeating cell pattern structure or from foam.

Furthermore, the invention relates to the use of the cutting machine blade according to the invention—as described above—fitted in a cutting machine with a cutting tool, as well as to a method for cutting composite plates of the aforementioned generic type by using a cutting machine with a cutting tool and a cutting machine blade according to the invention (as described above) fitted therein.

### BRIEF DESCRIPTION OF THE DRAWINGS

The device according to the invention and the method according to the invention will be described in more detail below, purely by way of example, with the aid of specific exemplary embodiments which are schematically represented in the drawings, further advantages of the invention also being discussed. In detail:

FIGS. 1 and 2a-2h show embodiments of oscillating blades corresponding to the prior art;

FIG. 3a shows an oscillating blade corresponding to a first embodiment according to the invention during the oscillating cutting of a composite plate;

FIG. 3b shows the oscillating blade corresponding to the first embodiment with indication of the functional division of the blade;

FIG. 4a-g show various views of the oscillating blade corresponding to the first embodiment in order to illustrate various special features;

FIG. 5 shows the oscillating blade corresponding to the first embodiment during the oscillating cutting of a composite plate, with indication of the movement path in a special stroke cutting mode;

FIG. 6a-c show various views of an oscillating blade corresponding to a second embodiment according to the invention;

FIG. 7a-c show various views of an oscillating blade corresponding to a third embodiment according to the invention;

FIG. 8a-c show outline diagrams of oscillating blades corresponding to a fourth, fifth and sixth embodiment according to the invention.

### DETAILED DESCRIPTION

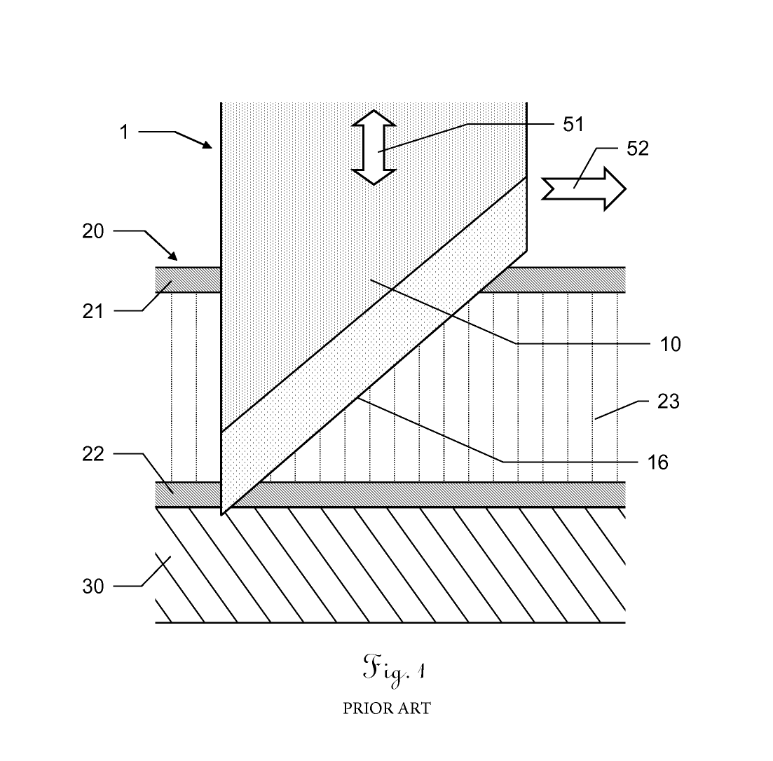

FIG. 1 shows an embodiment of a pointed oscillating blade according to the prior art during the oscillating cutting of a composite plate 20. The cutter 10 has an edge 16, which extends straight (obliquely upward in the drawing) over its entire extent, and therefore makes a single common angle over the entire edge extent with the feed direction 52, in which the blade is guided along the composite plate in the scope of a stroke cutting mode.

The composite plate 20 has an upper wall and separated therefrom a lower wall 21, 22, which are respectively relatively thick and difficult to cut, and an intermediate layer 23 lying between them, which is relatively easy to cut. As represented, the composite plate bears with its lower wall 22 typically on a cutting base 30 during the cutting process.

The edge 16 forms zones within which, in the scope of the stroke cutting mode, in particular essentially only the lower wall 22, especially essentially only the upper wall 21, and especially essentially only the intermediate structure 23 are cut. The zones are, however, identical in terms of their shape and the cutting angles of the profiles within the zones are respectively optimized for cutting the material in the corresponding stroke cutting mode and in the corresponding field of use (as regards the operating speeds and the cutting shapes of the parts).

In the scope of a stroke cutting mode, the blade—besides the advance movement in the feed direction 52 caused by the cutting machine—is also moved by the oscillating cutting tool, in which the blade is fitted, linearly downward and upward, being lowered and raised, in the stroke direction 51, for example with a sinusoidal stroke advance movement as regards the speed profile in the stroke direction.

As already mentioned in the introduction, a disadvantage found with the use of blades from the prior art with a continuously straight oblique shape of the edge is that, when cutting shaped parts made of thick composite plates (such as sandwich plates having at least two thick walls and a structure lying between them), which may then overall be for example 10, 16 or 20 mm thick, respectively undesired overcuts in the material (i.e. the upper wall is respectively cut further than the lower wall) are necessary, which inter alia also complicates the calculation of the cutting paths.

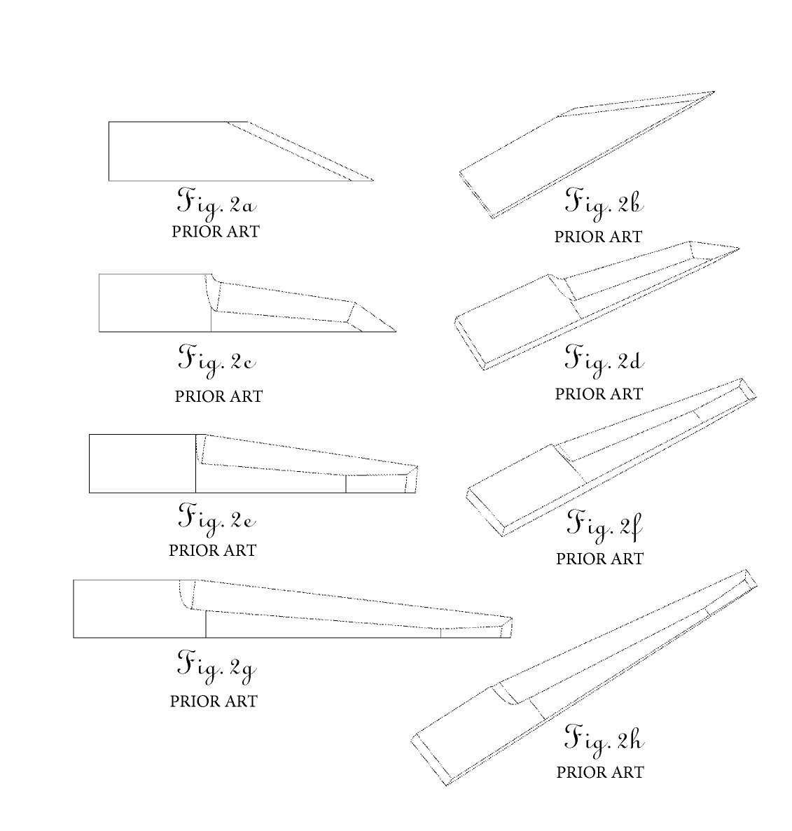

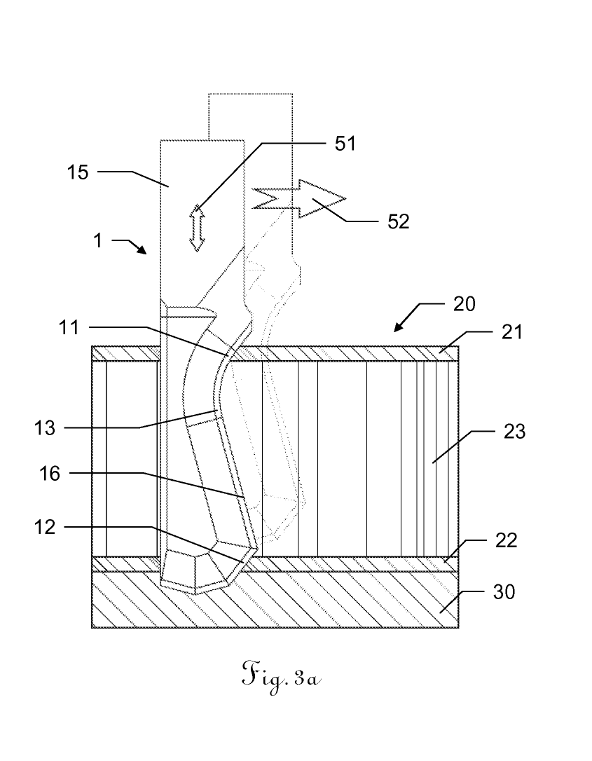

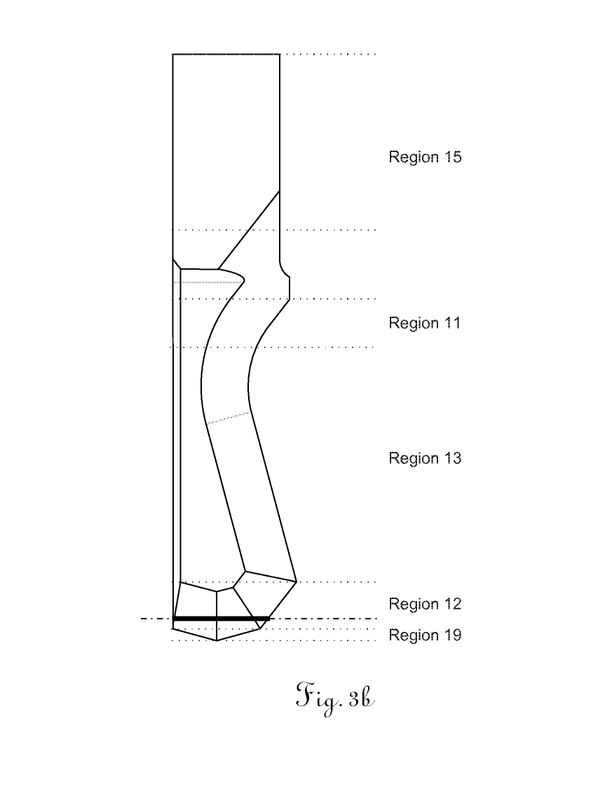

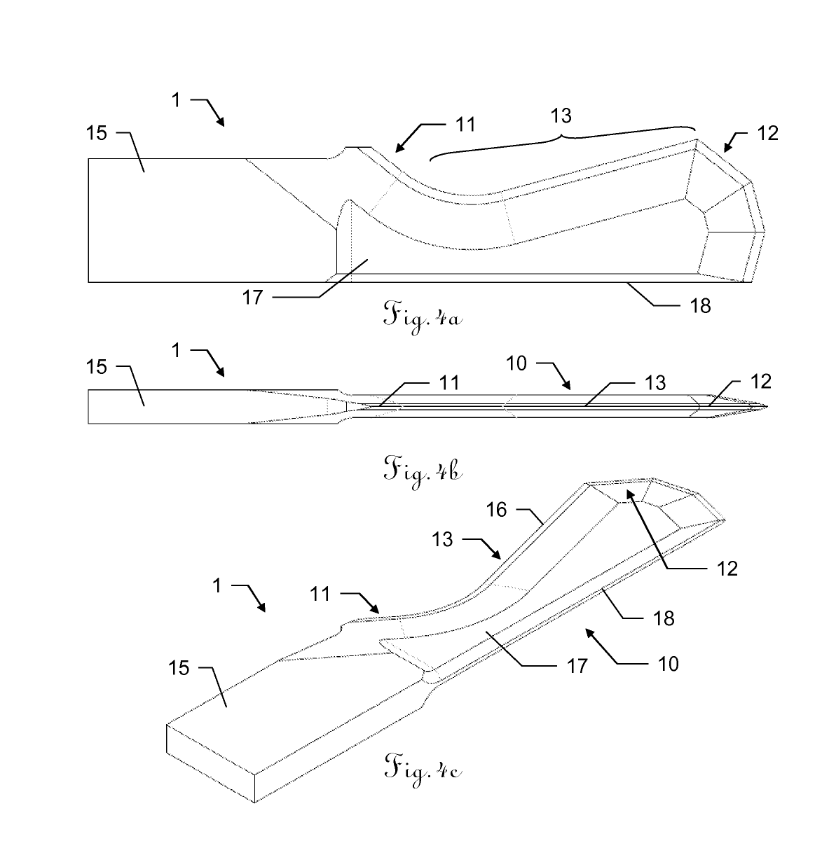

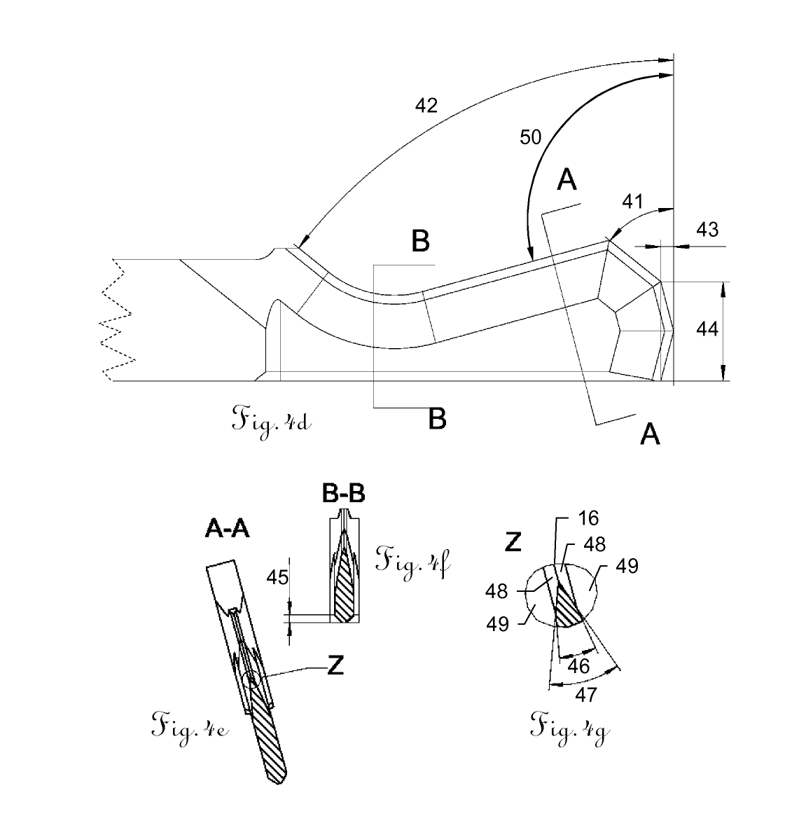

FIGS. 2a-2h show four further embodiments of oscillating blades corresponding to the prior art, respectively represented in two different views.

As already mentioned in the introduction, relatively flat blades (see FIGS. 2e-2h, with a very blunt blade tip region) are in this case in particular for:
high processing speed and
large radii, straight lines or large parts.

Relatively sharp blades (see FIGS. 1, 2a-2d) are in this case in particular for:
low processing speed and
fine radii, or small parts.

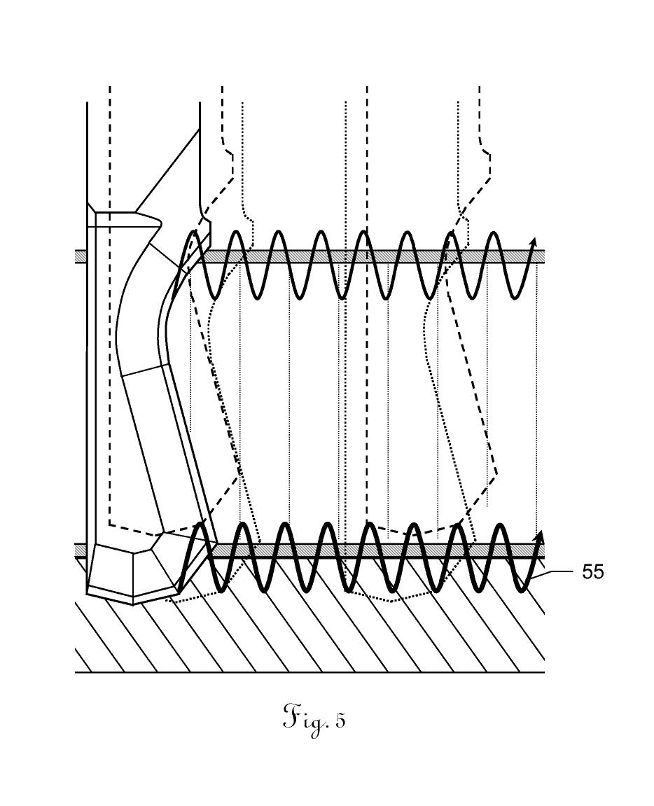

FIG. 3a shows an oscillating blade corresponding to a first embodiment according to the invention, during the oscillating cutting of a composite plate of the type already mentioned, with an upper wall 21 which is relatively difficult to cut, a lower wall 22 which is relatively difficult to cut, and an intermediate structure 23 which is relatively easy to cut. The composite plate lies—as is known to the person skilled in the art and is furthermore typical in this field of use—on a cutting base 30. The blade 1 corresponding to the first exemplary embodiment is in this case adapted, for example, for composite plates of medium thickness (having, for example, a thickness of in total about 16 mm).

In the scope of a stroke cutting mode, the blade—besides the advance movement in the feed direction 52 caused by the cutting machine—is also moved by the oscillating cutting tool, in which the blade is fitted, linearly downward and upward, being lowered and raised, in the stroke direction 51.

According to the invention, the cutter is now divided, or the geometry of the edge 16 is selected in terms of its shape, in such a way that
a first zone 12 of the edge 16 extending obliquely relative to the feed direction 52 is provided for the oscillating cutting of the lower wall 22, and
a second zone 11 of the edge 16 extending obliquely relative to the feed direction is provided for the oscillating cutting of the upper wall 21.

In this case, the respective profiles of the edge 16 in the region of the first and second zones 12, 11 respectively make a first angle of between about 30° and about 70° (here approximately 52°) with the feed direction 52.

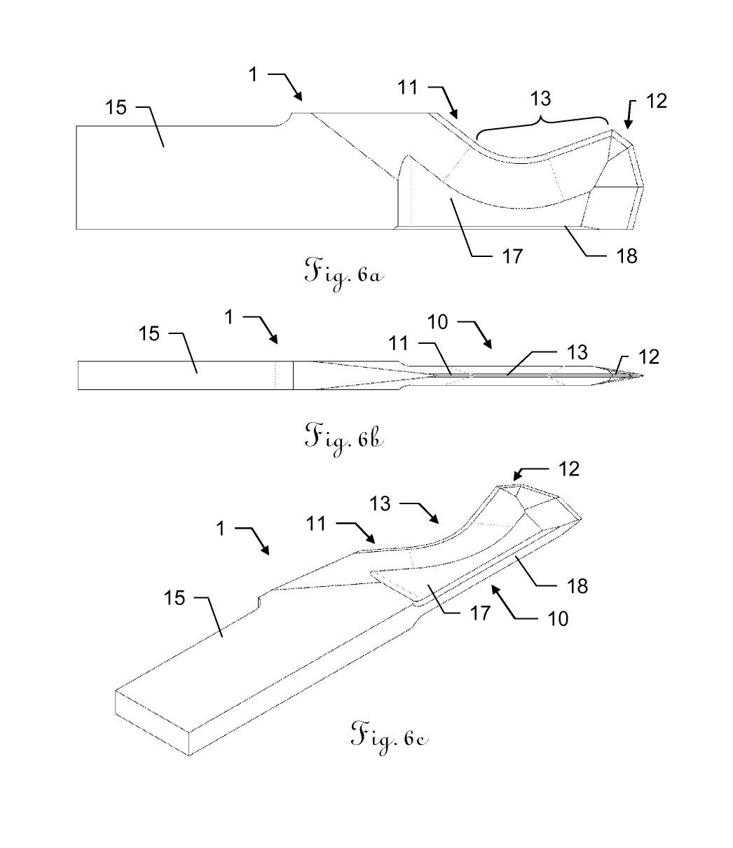

There is furthermore an intermediate zone 13 of the edge 16 between the first and second zones 12, 11, with a profile that makes a second angle with the feed direction 52 which is greater than the first angle, in particular greater than 90°. In the example shown (see also FIG. 4d in this regard), this second angle 50 lies approximately in the range of between 100° and 120°.

The edge 16 thus extends in the region of the intermediate zone 13 obliquely backward—relative to the feed direction—in such a way that the shapes of the edge within the first and second zones 12, 11—respectively projected orthogonally on to the feed direction 52—at least partially overlap. In the example shown, they essentially overlap fully, so that the shapes of the edge within the first and second zones 12, 11 are essentially parallel, and are only offset in a direction orthogonal to the feed direction 52.

As can furthermore be seen, the edge may, by way of example, respectively extend essentially straight within the first and second zones 12, 11.

The edge thus forms—as seen in the extent from the cutter tip in the direction of the holding section—the first zone 12 before the intermediate zone 13 and the intermediate zone 13 before the second zone 11.

FIG. 3b illustrates, again by way of example, the functional regions of the blade formed according to the embodiment of FIG. 3a.

At least region 19 fully penetrates into the cutting base at the lowest stroke point. Depending on the configuration, a part of region 12 may also penetrate into the cutting base. The dot and dash line represents the surface of the cutting base, just as the blade may lie at the lowest stroke point in one possible configuration of the stroke cutting mode. The length of the thickly represented line determines, with the stroke frequency, the maximum feed speed so that the material to be cut (i.e. the lower wall of the composite plate) can still be cut through fully. Regions 12 and 11 primarily cut the hard layers (i.e. the lower and upper walls, respectively) of the composite plate. Region 13 cuts the soft core. Region 15 (the holding section of the blade) is for fastening the blade in the cutting tool.

FIGS. 4a to 4g show various views of the oscillating blade according to the first embodiment in order to illustrate various special features.

The blade 1 has a holding section 15 for fitting the blade into a blade holder of a cutting tool, and a cutter 10 (there being a blade neck, here not very strongly pronounced, between the holding section 15 and the cutter 10).

The cutter has a cutter leaf 17, edge 16 (the cutter leaf respectively tapering at certain points in the shape of a wedge in the direction of the edge) and a cutter back 18.

The first zone 12, the intermediate zone 13 and the second zone 11 of the blade 16 are also in turn indicated in these views, shown in FIGS. 4a-c, of the first embodiment according to the invention of an oscillating blade 1.

The blade is in this case formed with a flat cutter tip. The edge extends over the entire cutter tip, and the cutter tip thus has—in comparison with the profile within the first zone—a flatter profile relative to the feed direction (i.e. it is inclined less relative to the feed direction).

The edge has a geometry in the region of the cutter tip which is axisymmetric in the stroke direction with two cutter tip zones, which form a flat vertex lying on the symmetry axis and respectively have—in comparison with the profile within the first zone 12—profiles extending less obliquely relative to the feed direction, in particular with the profiles of the two cutter tip zones making angles with the feed direction of between about 2° and about 30° and respectively between about 150° and 178°, in particular between about 10° and about 20° and respectively between about 160° and 170°, in particular—as specifically in the example represented here—about 15° and respectively about 165°.

Such a profile of the edge in the region of the cutter tip can be advantageous when the blade penetrates into the cutting base, since by the bend, or the symmetry in the cutter tip, on the one hand, a slightly oblique edge shape which is advantageous for the penetration can be ensured in the entire cutter tip region, and on the other hand the penetration depth into the base can nevertheless be kept small (specifically, can be halved)—compared with an unbent tip extending slightly obliquely.

As already mentioned in connection with FIG. 3b, the width 44 (see FIG. 4d) of the cutter tip region determines, together with the stroke frequency, the maximum feed speed so that the material to be cut (i.e. the lower wall of the composite plate) can still be cut through fully. Depending on the stroke mode in which operation is intended to be carried out, the blade, or its geometry, is thus to be adapted specially to the feed speed used in this case, as well as the stroke frequency, particularly as regards the first angles 41, 42 (i.e. angles which are made with the feed direction by the respective profiles within the first and second zones of the edge), but also as regards the width 44 of the flat blade tip (i.e. the extent of the tip in the feed direction) as well as the flatness 43 of the tip (i.e. the extent of the tip in the stroke direction). These cutter geometry parameters for the blade are specially indicated in FIG. 4d.

For the cutting of corresponding sandwich plates, for example, a stroke cutting mode may specifically be envisioned which has a stroke of between about 0.2 and about 12 millimeters, a stroke frequency of between about 50 and about 800 Hz, and a cutting speed in the feed direction of between about 0.1 and about 4 meters per second. In particular, the stroke cutting mode may have a stroke of between about one and about five millimeters, in particular between about two and about three millimeters, a stroke frequency of between about 100 and about 500 Hz, in particular between about 200 and about 300 Hz, and a cutting speed in the feed direction of between about 0.5 and about 2 meters per second, in particular between about 0.75 and about 1.5 meters per second. The geometry of the blade according to the invention may thus in this case be advantageously specially optimized for such a stroke cutting mode.

The cutter with the edge may therefore advantageously—for instance optimized for a stroke mode with a stroke of for example about 2.5 mm, a stroke frequency of for example about 250 Hz and a feed speed of for example about 1 m/s—be formed in such a way that the first angles 41, 42 made with the feed direction by the respective profiles of the edge in the region of the first and second zones are respectively between about 30° and about 70°, in particular between about 45° and about 60°, and particularly are about 52°. Furthermore, the cutter tip may in this case be formed in such a way that it has an extent or length (i.e. width 44) in the feed direction of about 0.5-10 millimeters, particularly between about 3 and about 6 millimeters, in particular about 4.5 millimeters.

FIG. 4e shows a sectional representation A-A of the cutter of the blade, the corresponding section A-A being indicated in FIG. 4d. The optionally two-stage wedge-like shape of the cutter from the cutter leaf to the edge 16 can be seen in this cross-sectional representation A-A—but particularly in FIG. 4g which shows the enlarged detail Z. The first surfaces 48, directly forming the edge 16, of the edge wedge taper less acutely than convergent second surfaces 49 of the wedge, extending between the first surfaces 48 and the cutter leaf, in particular with the first surfaces 48 forming a cutting angle 47 of between about 15° and 50° and the second surfaces 49 converging with an angle 46 which is between about 3° and 20° less than the edge angle 47. In particular, the edge angle 47 may advantageously be selected in such a way that it lies between about 25° and about 35°, in particular about 30°, and the angle 46 may advantageously be selected in such a way that it is between about 5 and 12.5° less than the edge angle 47, in particular about 20°.

The thickness of the cutter leaf, the two cutter leaf surfaces (i.e. the front and rear surfaces of the cutter leaf) advantageously being aligned mutually parallel, may for example be between about 0.4 and about 3 millimeters.

FIG. 4f shows a sectional representation B-B—the section B-B being indicated in FIG. 4d—of the cutter of the blade. In particular, the optional feature that the two lips, which the two cutter leaf surfaces form with the cutter back, may be chamfered, can be seen in this cross-sectional representation B-B.

In particular, chamfers (for example at an angle of about 45° with respect to the back, or the cutter leaf surfaces) may be produced with an extent 45 in the feed direction of between about 0.05 and 2 mm (depending on the thickness of the cutter leaf).

Such a chamfered cutter back can offer advantages, particularly when cutting radii (->less friction, scratching and/or jamming of the material to be cut on the cutter back) as well as during the first perpendicular penetration of the cutter into the material and when extracting the cutter at the end of a cutting process.

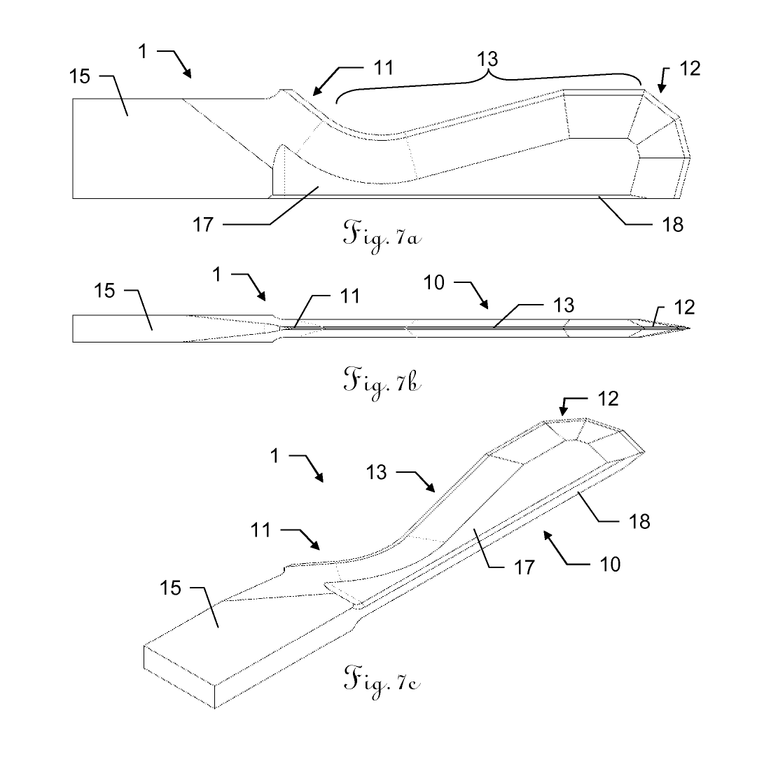

FIG. 5 shows the oscillating blade corresponding to the first embodiment during the oscillating cutting of a composite plate, the movement path of the lower end of the first zone of the edge, executed in a special stroke cutting mode with stroke movements with a sinusoidal speed profile, being indicated (see the thick sinusoidal line). The thin sinusoidal line indicates the movement path 55 executed by the lower end of the second zone of the edge, which cuts the upper wall of the composite plate.

The stroke movement itself is thus configured linearly sinusoidally here, so that a sinusoidal curve as a combined movement path 55 is obtained from the two movements in combination. As an alternative, however, a stroke movement with uniform movement for the lowering as well as uniform movement for the raising may also be applied (so that a sawtooth-like curve is obtained as a path in combination with the forward movement).

As can be seen from the movement path 55 indicated (and also already mentioned in connection with FIG. 3b), the cutting machine blade can thus be accurately provided in order to cut the composite plate lying with the lower wall flat and directly on a cutting base, to which end the cutter with its cutter tip being formed in such a way that—while being adapted to the composite plate to be cut and the stroke cutting mode intended for use—during the oscillating cutting, the cutter tip cuts—each time the cutting machine blade is lowered in the stroke cutting mode—into the cutting base.

Furthermore—as can likewise be seen in FIG. 5 from the shape of the movement path 55 in connection with the represented first and second zones of the edge as well as the lower and upper walls of the composite material—the cutter with its cutter tip may be formed while being adapted accurately to the composite plate to be cut and to the stroke cutting mode intended to be used, in such a way that—when the cutting machine blade is respectively lowered in the stroke cutting mode—the lower wall is essentially cut only by the first zone of the edge and of the cutter tip, and the upper wall is cut essentially only by the second zone of the edge.

FIGS. 6a-c show various views of an oscillating blade 1 corresponding to a second embodiment according to the invention. The second embodiment is identical to the first embodiment in terms of almost all features, except for the aspect that the blade according to the second embodiment is optimized and specially adapted for cutting composite plates which are less thick in comparison (i.e. plates with a less thick intermediate layer), i.e. composite plates with an overall smaller thickness (having, for example, a thickness of in total about 10 mm).

The intermediate zone 13 is—in comparison with the blade according to the first embodiment—formed to be correspondingly shorter. Furthermore, the first zone 12 may also—in comparison with the blade according to the first embodiment—be configured somewhat shorter.

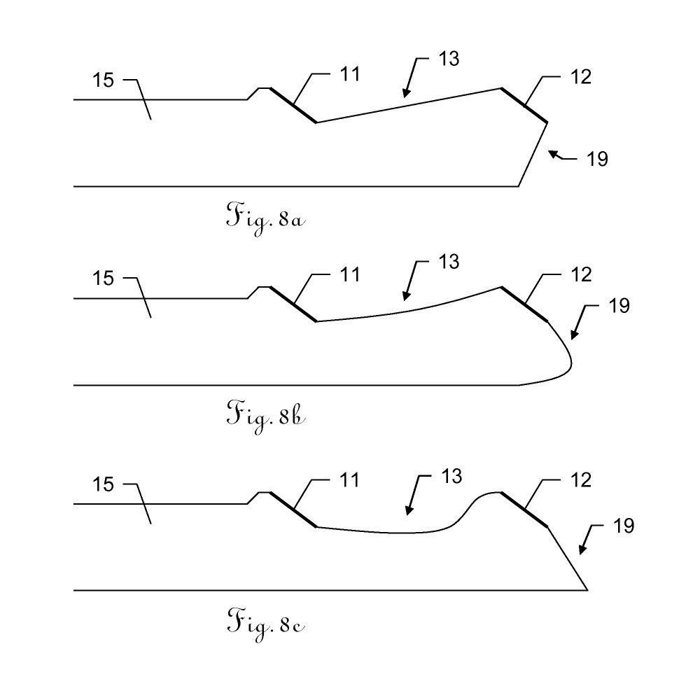

FIGS. 7a-c show various views of an oscillating blade corresponding to a third embodiment according to the invention. The third embodiment is identical to the first and second embodiments in terms of almost all features, except for the aspect that the blade according to the third embodiment is optimized and specially adapted for cutting relatively thick composite plates (i.e. plates with a thick intermediate layer), i.e. composite plates with an overall greater thickness (having, for example, a thickness of in total about 20 mm or more).

The intermediate zone 13 is—in comparison with the blade according to the first embodiment—formed to be correspondingly longer, and furthermore has an additional section within this intermediate zone, inside which the edge initially extends at an angle of for example 90° relative to the feed direction, before a section within the intermediate zone then follows with an angle of the edge shape there of for example between 105° and 120° relative to the feed direction.

FIGS. 8a-c show outline diagrams of oscillating blades corresponding to a fourth, fifth and six embodiment according to the invention, from which possible variants according to the invention of the edge geometry or of the edge shape—particularly in regions of the edge inside the intermediate zone 13 and the cutter tip 19—may be derived according to the principle.

It is to be understood that these figures as represented only schematically represent possible exemplary embodiments. The various approaches may likewise be combined with one another or with devices or methods of the prior art.

What is claimed is:

1. Cutting machine blade (1) to be fitted into a cutting tool of a cutting machine, built and specifically intended for cutting a multiwalled composite plate (20)—particularly a sandwich plate—made of cardboard or paperboard material or plastic, which has at least an upper wall and separated therefrom a lower wall (21, 22), which are respectively relatively thick and difficult to cut, and an intermediate layer (23) lying between them, which is relatively easy to cut, particularly in the form of a structure between five and 60 millimeters high made of material with cavities, in particular formed as a repeating cell pattern structure or from foam,
wherein the cutting machine blade (1) is intended for use in the scope of an automatic cutting mode, in which the cutting machine blade (1) is guided by the cutting machine in a feed direction (52) along the composite plate (20),
having
a holding section (15) for fitting the cutting machine blade (1) into a blade holder of the cutting tool, and
a cutter (10) with an edge, a first zone (12) of the edge (16) extending obliquely relative to the feed direction (52) being provided for cutting the lower wall (22), and a second zone (11) of the edge (16) extending obliquely relative to the feed direction (52) being provided for cutting the upper wall (21), respective profiles of the edge (16) in the region of the first and second zones (12, 11) respectively making a first angle (41, 42) of between about 30° and about 70° with the feed direction (52),
characterized in that
there is an intermediate zone (13) of the edge (16) between the first and second zones (12, 11), with a profile that makes a second angle (50) with the feed direction (52) which is greater than the first angle (41, 42), in particular greater than 90°.

2. Cutting machine blade (1) according to claim 1,
characterized in that
the edge (16) extends obliquely backwards—relative to the feed direction (52)—in the region of the intermediate zone (13), in such a way that the shapes of the edge (16) within the first and second zones (12, 11)—respectively projected orthogonally on to the feed direction (52)—at least partially overlap, and in particular overlap essentially fully, in particular so that the shapes of the edge (16) within the first and second zones (12, 11) are essentially parallel, and are only offset in a direction orthogonal to the feed direction (52).

3. Cutting machine blade (1) according to claim 1 or 2,
characterized in that
the edge (16) respectively extends essentially straight within the first and second zones (12, 11).

4. Cutting machine blade (1) according to one of the preceding claims,
characterized in that
lips formed by the cutter back (18) and respective front and rear surfaces of the cutter leaf (17) are chamfered.

5. Cutting machine blade (1) according to one of the preceding claims,
characterized in that
the edge (16)—as seen in the extent from the cutter tip (19) in the direction of the holding section (15)—forms the first zone (12) before the intermediate zone (13) and the intermediate zone (13) before the second zone (11).

6. Cutting machine blade (1) according to one of the preceding claims,
characterized in that
the cutter (10) tapers in two stages in the shape of a wedge from the cutter leaf (17) to the edge (16), first surfaces (48) of the wedge, directly forming the edge (16) tapering less acutely than convergent second surfaces (49) of the wedge, extending between the first surfaces (48) and the cutter leaf (17), in particular with the first surfaces (48) forming an edge angle of between about 15° and 50°, and the second surfaces (49) converging with an angle which is between about 3° and 20° less than the edge angle.

7. Cutting machine blade (1) according to one of the preceding claims,
characterized in that
the cutting machine blade (1) is formed as an oscillating blade to be fitted in an oscillating cutting tool, and is intended for use in the scope of a defined stroke cutting mode, in which the cutting machine blade (1)—in addition to the guiding along the feed direction (52)—is moved by the cutting tool oscillating up and down in a stroke direction (51) essentially perpendicularly to the composite plate (20) to be cut, in particular with the stroke cutting mode having a stroke of between about 0.2 and about 12 millimeters, a stroke frequency of between about 50 and about 800 Hz, and a cutting speed in the feed direction (52) of between about 0.1 and about 4 meters per second,
in particular with the stroke cutting mode having a stroke of between about one and about five millimeters, particularly between about two and about three millimeters, in particular about 2.5 millimeters, a stroke frequency of between about 100 and about 500 Hz, particularly between about 200 and about 300 Hz, in particular about 250 Hz, and a cutting speed in the feed direction (52) of between about 0.5 and about 2 meters per second, particularly between about 0.75 and about 1.5 meters per second, in particular about one meter per second.

8. Cutting machine blade (1) according to claim 7,
characterized in that
the edge (16) extends over the cutter tip (19), and the cutter tip (19) has—in comparison with the profile within the first zone (12)—a flatter profile relative to the feed direction (52).

9. Cutting machine blade (1) according to claim 7 or 8,
characterized in that
the edge (16) has a geometry in the region of the cutter tip (19) which is axisymmetric in the stroke direction (51) with two cutter tip zones, which form a flat vertex lying on the symmetry axis and respectively have—in comparison with the profile within the first zone (12)—profiles extending less obliquely relative to the feed direction (52), in particular with the profiles of the two cutter tip zones making angles with the feed direction (52) of between about 2° and about 30° and respectively between about 150° and 178°, in particular between about 10° and about 20° and respectively between about 160° and 170°, in particular about 15° and respectively about 165°.

10. Cutting machine blade (1) according to one of claims 7 to 9,
characterized in that
the cutter tip (19) has an extent (44) in the feed direction (52) of about 0.5-10 millimeters,
particularly between about 3 and about 6 millimeters, in particular about 4.5 millimeters.

11. Cutting machine blade (1) according to one of claims 7 to 10,
characterized in that
the cutting machine blade (1) is accurately provided in order to cut the composite plate (20) lying with the lower wall (22) flat and directly on a cutting base (30),
to which end the cutter (10) with its cutter tip (19) is formed in such a way that—while being adapted to the composite plate (20) to be cut and the stroke cutting mode intended for use—during the oscillating cutting the cutter tip (19) cuts—each time the cutting machine blade (1) is lowered in the stroke cutting mode—into the cutting base (30),
in particular with—for the case in which the edge (16) has a geometry in the region of the cutter tip (19) which is axisymmetric in the stroke direction (51) according to the feature of claim 9—a penetration depth of the blade at the lowest point of the oscillating movement which is less—in particular half as deep—as in the case of a corresponding imaginary blade with an edge (16) which is not bent but that extends similarly obliquely in the region of the cutter tip (19).

12. Cutting machine blade (1) according to one of claims 7 to 11,
characterized in that
the cutter (10) is adapted accurately to the composite plate (20) to be cut and to the stroke cutting mode intended to be used in such a way that—each time the cutting machine blade (1) is lowered in the stroke cutting mode—the lower wall (22) is cut essentially only with the first zone (12) of the edge (16) and the cutter tip (19), and the upper wall (21) is cut essentially only with the second zone (11) of the edge (16).

13. Cutting machine blade (1) according to one of the preceding claims,
characterized in that
the cutter (10) with the edge (16) is formed in such a way that the first angle (41, 42) made with the feed direction (52) by the respective profiles of the edge (16) in the region of the first and second zones (12, 11) is between about 40° and about 65°, particularly between about 45° and about 60°, in particular about 52°.

14. Cutting machine having a cutting tool, which has a blade holder in which a cutting machine blade (1) according to one of claims 1 to 13 is fitted, wherein the cutting machine provides a cutting mode in which the cutting machine blade (1) is guided by the cutting machine in a feed direction (52) along the composite plate (20), in which the cutting machine with the fitted cutting machine blade (1) is accurately formed and provided in order to cut a multiwalled composite plate (20)—particularly a sandwich plate—made of cardboard or paperboard material or plastic, which has at least an upper wall and separated therefrom a lower wall (21, 22), which are respectively relatively thick and difficult to cut, and an intermediate layer (23) lying between them, which is relatively easy to cut, particularly in the form of a structure between five and 60 millimeters high made of material with cavities, in particular formed as a repeating cell pattern structure or from foam,
particularly with the cutting machine blade (1) being formed as an oscillating blade and the cutting tool being formed as an oscillating cutting tool, and the cutting machine and the cutting tool providing a stroke cutting mode, in which the cutting machine blade (1)—in addition to the guiding along the feed direction (52)—is moved by the cutting tool oscillating up and down in a stroke direction (51) essentially perpendicularly to the composite plate (20) to be cut, in particular with the stroke cutting mode having a stroke of between about 0.2 and about 12 millimeters, a stroke frequency of between about 50 and about 800 Hz, and a cutting speed in the feed direction (52) of between about 0.1 and about 4 meters per second.

15. Use of the cutting machine blade (1) according to one of claims 1 to 13 when fitted in a cutting machine having a cutting tool.
